(19) United States
(12) Patent Application Publication
(10) Pub. No.: US 2023/0295403 A1
(43) Pub. Date: Sep. 21, 2023

(54) PURGING COMPOUND FOR RESIN PROCESSING MACHINE AND PURGING METHOD OF RESIN PROCESSING MACHINE

(71) Applicant: ASAHI KASEI KABUSHIKI KAISHA, Tokyo (JP)

(72) Inventors: Yohei NOBE, Tokyo (JP); Takafumi IWAI, Tokyo (JP); Shunichiro I, Tokyo (JP); Shigeru ENDO, Tokyo (JP)

(73) Assignee: ASAHI KASEI KABUSHIKI KAISHA, Tokyo (JP)

(21) Appl. No.: 18/185,369

(22) Filed: Mar. 17, 2023

(30) Foreign Application Priority Data
Mar. 18, 2022 (JP) 2022-044721
Mar. 14, 2023 (JP) 2023-040131

(51) Int. Cl. C08L 23/06; C08L 23/12; C08L 25/06

(52) U.S. Cl. CPC C08L 23/06; C08L 23/12; C08L 25/06

(57) ABSTRACT

[Problem] An object of the present disclosure is to provide a new purging compound for a resin processing machine made from a resin derived from a biomass raw material which reduces the environmental load, and has a purging performance comparable to those of conventional purging compounds for a resin processing machine. [Solution] A purging compound for a resin processing machine contains 10 to 97% by mass of a resin having a bio degree of 30% or more with respect to 100% by mass of the purging compound, wherein the resin has a weight average molecular weight of 200,000 or more and 1,500,000 or less, and a ratio of the weight average molecular weight to the number average molecular weight (Mw/Mn) of 8 or less.

### TECHNICAL FIELD

The present disclosure relates to a purging compound for a resin processing machine and a purging method of a resin processing machine.

### BACKGROUND

In a resin processing machine such as a molding machine, the change procedures of removal of dirt of a previously used resin after use, resin change to switch a resin to another resin, and color change for performing colorful color molding all require a process of removing the previously used resin, known as purging. This process requires use of a large amount of a virgin resin for the purging operation, which is problematic because a previously used resin derived from petroleum is consumed. Materials known as purge compounds or purging compounds, which enable more efficient purging, can greatly reduce the amount of resins used, and are widely recognized as materials that contribute to the environment.

Purge compounds or purging compounds are made primarily from resin materials derived from fossil fuels such as petroleum. In light of the recent social trends toward carbon neutrality, there still remain a problem from the viewpoint of use of fossil fuel resources and carbon neutrality.

### CITATION LIST

### Patent Literature

PTL 1: JP H11-227000 A

PTL 2: JP 2017-80928 A

### SUMMARY

### Technical Problem

In such a social situation, developments of purging compounds made from raw materials considering the environment have begun, and purging compounds made from recycled resins or biodegradable resins as the raw materials fall into this category. PTL 1 proposes use of polyethylene terephthalate resin scraps which are recyclable materials, and PTL 2 proposes use of polylactic acid.

PTL 1 has a problem in terms of melting points of polyethylene terephthalate resins which are higher than the temperature range suitable for purging typical general-purpose resins and engineering plastics. PTL 2 has a problem in terms of the availability of polylactic acid as a resin, the heat resistance, and the like. As discussed above, design of compounds which can provide performances as purging compounds has not been sufficiently studied yet.

If resin raw materials used as general-purpose resins are switched from conventional virgin resins derived from fossil fuels such as petroleum to biomass raw materials, it would be possible to expand the design of general-purpose purging compounds and contribute to the environment through use of biomass raw materials.

Biomass resins such as biopolyethylene, biopolypropylene, and biopolystyrene-based resins, which are produced from generally-used biomass, are made from biomass sources such as plants (sugarcane), tall oil, or waste oil, and are converted into a resin via bioethanol or bionaphtha serving as raw materials. Currently, manufacturing plants are limited due to the complexity of the process, and grade types, etc. are also limited. In addition, the content ratio of impurities, presence or absence of low molecular weight components, the molecular weight, the heat resistance, and other physical properties may differ from those of conventional fossil fuel-derived resins, due to differences in raw materials or polymerization processes. Thus, control on product properties different from those of conventional fossil fuel-derived resins is required.

Accordingly, an object of the present disclosure is to provide a new purging compound for a resin processing machine which is made from a resin derived from a biomass raw material and reduces the environmental load and has a purging performance comparable to those of conventional purging compounds for a resin processing machine.

### Solution to Problem

As a result of diligent study to solve the above problem, the present inventors have discovered that, when a purging compound containing a certain amount of a biomass resin having a bio degree in a specific range was used, use of a resin having specific molecular weight and molecular weight distribution provided a purging performance comparable to or higher than those of conventional purging compounds, so that the above problem was solved, thereby completing the present disclosure.

Thus, the present disclosure is as follows.

[1]

A purging compound for a resin processing machine, the purging compound comprising:

10 to 97% by mass of a resin having a bio degree of 30% or more with respect to 100% by mass of the purging compound,

wherein the resin has a weight average molecular weight of 200,000 or more and 1,500,000 or less, and a ratio of the weight average molecular weight to a number average molecular weight (Mw/Mn) of 8 or less.

[2]

The purging compound for a resin processing machine according to [1], wherein a melt flow rate of the resin at 240 ° C., 5.0 Kg is 0.1 to 30 g/10 min.

[3]

The purging compound for a resin processing machine according to [1] or [2], wherein the resin is a resin obtained by polymerizing at least one selected from the group consisting of bioethanol and bionaphtha as a raw material.

[4]

The purging compound for a resin processing machine according to any one of [1] to [3], having a bio degree of 3% to 97%.

[5]

The purging compound for a resin processing machine according to any one of [1] to [4], comprising at least one lubricant selected from the group consisting of low molecular polyolefin waxes derived from petroleum, mineral oils, natural waxes, plant-derived waxes, and fluorine modified resins.

[6]

The purging compound for a resin processing machine according to any one of [1] to [5], wherein the resin is a polyethylene, polypropylene, or polystyrene-based resin.

[7]

The purging compound for a resin processing machine according to any one of [1] to [6], comprising an inorganic compound.

[8]

A purging method of a resin processing machine, the purging method comprising using the purging compound for a resin processing machine according to any one of [1] to [7].

### Advantageous Effect

According to the present disclosure, when a purging compound containing a certain amount of a biomass resin having a bio degree in a specific range is used, use of a resin having specific molecular weight and molecular weight distribution can provide a purging compound for a resin processing machine which reduces the environmental load and provides a purging performance comparable to those of conventional purging compounds that contain resin raw materials derived from fossil fuels.

### DETAILED DESCRIPTION

The following provides a detailed description of an embodiment of the present disclosure (hereinafter, referred to as the “present embodiment”). Note that the following present embodiment is merely an example for describing the present disclosure and is not intended to limit the present disclosure to the embodiment thereof. Furthermore, various modifications may be made to the present disclosure without departing from the gist thereof.

### Purging Compound for Resin Processing Machine

A purging compound for a resin processing machine of a present embodiment contains 10 to 97% by mass of a resin having a bio degree of 30% or more with respect to 100% by mass of the purging compound, wherein the above resin has a weight average molecular weight of 200,000 or more and 1,500,000 or less, and a ratio of the weight average molecular weight to the number average molecular weight (Mw/Mn) of 8 or less.

The above purging compound for a resin processing machine may also contain a component other than the above resin, such as an inorganic compound, a lubricant, a virgin thermoplastic resin derived from fossil fuels, a surfactant, and an antioxidant.

The following describes the respective components of the resin compound of the present embodiment in detail.

In this specification, a “biomass resin” refers to a resin made from a raw material derived at least in part from biomass, and does not mean that all of the raw materials are derived from biomass.

Further, in this specification, the purging compound for a resin processing machine is sometimes simply referred to as “purging compound”. Further, the ratio of the weight average molecular weight to the number average molecular weight (Mw/Mn) is sometimes referred to as “Mw/Mn”.

### Resin Having Bio Degree of 30% or More

The above resin having a degree of 30% or more contains a bioethanol or bionaphtha component derived from biomass at a ratio (bio degree) of preferably 30% or more and more preferably 50% or more with respect to the total resin. As the ratio of the biomass component increases, use of conventional fossil fuels can be more reduced and a resin contributing to carbon neutrality is provided.

In this specification, a resin having a bio degree of 30% or more is sometimes simply referred to as the “resin”.

The above resin is generally referred to as a biomass resin or a bioresin, and examples thereof specifically include commonly-used thermoplastic resins. Biopolyolefins, such as biopolyethylene and biopropylene, are generally used, but copolymerization with an α-olefins, a vinyl alcohols, methacrylic acid, a methacrylic acid ester, styrene, maleic anhydride, maleimide, butadiene, and the like, or compounding with polystyrene or other engineering plastics is also possible. As the content ratio of monomers derived from bioethanol or bionaphtha is increased, the contribution to the environment is increased. Recycled monomers such as styrene, ethylene, and propylene produced in chemical recycling through depolymerization can also be used as monomers to be polymerized, and are more preferred because the environmental load can be reduced.

The above resin is preferably polyethylene, polypropylene, and/or polystyrene-based resin, and polyethylene or polypropylene is more preferred.

As biopolyolefins such as biopolyethylene and biopolypropylene, homopolymers, random copolymers, block copolymers, and the like are exemplified. Biopolyolefins may contain an olefin other than the biopolyolefins as a monomer component.

Examples of the monomer other than ethylene which composes biopolyethylene include propylene, α-olefins having a carbon number of 4 to 8, vinyl alcohols, methacrylic acid, methacrylic acid ester, styrene, maleic anhydride, maleimide, and butadiene. The mass ratio of constituent units derived from ethylene with respect to 100% by mass of the biopolyethylene may be greater than 30% by mass, preferably greater than 50% by mass, and more preferably greater than 70% by mass, as the bio degree. Examples of the type of biopolyethylene include, for example, high-density polyethylene, low-density polyethylene, and linear low-density polyethylene.

Examples of the monomer other than propylene which composes biopolypropylene include α-olefins having a carbon number of 4 to 8, vinyl alcohols, methacrylic acid, methacrylic acid esters, styrene, maleic anhydride, maleimide, and butadiene. The mass ratio of constituent units derived from propylene with respect to 100% by mass of the biopolypropylene may be greater than 30% by mass, preferably greater than 50% by mass, and more preferably greater than 70% by mass, as the bio degree.

One of these bioresins may be used or two or more of these may be blended.

Biopolystyrene-based resins are a group of resins made from biostyrene monomers or derivatives of biostyrene monomers in the main backbone, and can be produced from bionaphtha or the like as the raw material by copolymerizing styrene monomer with a monomer component, such as butadiene, acrylonitrile, ethylene, methacrylic acid ester, and β-Farnesene. A biopolystyrene-based resin can be produced by copolymerizing any of these components by using a bio-based raw material. The mass ratio of constituent units derived from a bio-based raw material with respect to 100% by mass of the biopolystyrene-based resin may be more than 30% by mass, preferably more than 50% by mass, and more preferably more than 70% by mass, as the bio degree.

The ratio of biomass-derived carbon to total carbon amount in a resin is referred to as the bio degree, and the above resin has a defined bio degree. It is determined by measuring the concentration of ¹⁴C contained in carbons. While ¹⁴C is not contained in carbons in petroleum-derived resins, ¹⁴C in the atmosphere is immobilized into bio-based raw materials in certain percentages. Accordingly, the bio degree can be determined by measuring the concentration of ¹⁴C in a biopolymer. If all carbons in the resin are derived from plants, the bio degree is 100%. One test method used to determine the ¹⁴C concentration is the method of ASTM D6866 which is the standard for determining bio-derived carbon concentration in samples using radiocarbon dating. Various test methods are known, including liquid scintillation counting (LSC), accelerator mass spectrometry (AMS), and stable isotope ratio mass spectrometry (IRMS). A measurement can be made on a sample in the form of pellets. When the above resin in the form of raw material pellets is produced using only a biomass-derived monomer raw material, the bio degree is 100%. Otherwise, when the monomer raw material includes a fossil-derived monomer raw material, the bio degree is less than 100%. The above bioresin has a bio degree of preferably 30% or more, more preferably 50% or more, and even more preferably 70% or more. A bio degree of less than 30% is undesirable because the percentage of contribution to the environment in carbon dioxide emissions decreases. It is also possible to analyze and evaluate the bio degree of the purging compound by analyzing the purging compound per se. The bio degree of the purging compound is preferably in the range of 3% to 97%, more preferably 5% to 97%, and even more preferably in the range of 10% to 97%. A bio degree of the purging compound of less than 3% is undesirable because the percentage of contribution to the environment in carbon dioxide emissions decreases. More than 97% is undesirable because use of a resin having a bio degree higher than those of resins derived from fossil fuels makes the purging compound more susceptible to influences of impurities and low molecular weight, making it difficult to exhibit the physical properties as a purging compound.

The melt flow rate of the above resin at 240° C., 5.0 Kg is preferably 0.1 to 30 g/10 min, more preferably 0.2 to 25 g/10 min, and even more preferably 0.3 to 15 g/10 min. The above melt flow rate is the value obtained by the method specified in ISO-1133-1 (2011) under conditions of a temperature of 240° C. and a load of 5.0 kg. An MFR of less than 0.1 g/10 min is undesirable because the viscosity of the resin becomes too high, which reduces processability during extrusion and makes the residue to more likely remain inside the cylinder. If the MFR is more than 30 g/10 min, the fluidity of the resin becomes excessively high, which reduces the effect of expelling dirt. If the content of low molecular weight components is extremely high, gases are generated or low molecular weight components are degraded due to heat, resulting in coloration or the like.

The weight average molecular weight of the above resin is 200,000 or more and 1,500,000 or less, preferably 300,000 or more and 1,300,000 or less, and more preferably 350,000 or more and 1,000,000 or less. A high content of high molecular weight components is undesirable because the viscosity of the resin becomes too high, which reduces processability during extrusion and makes the residue to more likely remain inside the cylinder. If the content of low molecular weight components is high, the fluidity of the resin becomes excessively high, which reduces the effect of expelling dirt. If the content of low molecular weight components is extremely high, gases are generated or low molecular weight components are degraded due to heat, resulting in coloration or the like.

The ratio of the weight average molecular weight to the number average molecular weight (Mw/Mn) of the above resin is 8 or less, preferably 6 or less, more preferably 5 or less. The molecular weight distribution can be estimated from the above Mw/Mn. If the molecular weight distribution is large (e.g., if the above Mw/Mn is more than 8), the amount of low molecular weight components generated during polymerization increases. As a result, processing becomes unstable, the purging performance reduces, and gases are generated or low molecular weight components are degraded due to heat, resulting in coloration or the like.

In this specification, the weight average molecular weight and molecular weight distribution (Mw/Mn) of the resin and additives can be measured by gel permeation chromatography (GPC). Various mixed resins can be separated by using a GPC with a preparation function. For polyolefins, a GPC which allows for measurements at high temperatures with solvents such as o-dichlorobenzen is used.

### Production Method of Resin

Examples of a production method of the above resin include a method in which biomonomers are polymerized using plant-derived bioethanol as a raw material, a method in which biomonomers are produced from waste edible oil, tall oil, etc., and the resultant biomonomers are polymerized to produce a biomass resin, and a method in which bionaphtha obtained from other raw materials are polymerized.

In particular, it is preferable that the above resin is a resin obtained by polymerizing a raw material containing at least one selected from the group consisting of bioethanol and bionaphtha, and it is more preferable that the resin is a resin obtained by polymerizing a raw material consisting only of at least one selected from the group consisting of bioethanol and bionaphtha.

The above bioethanol refers to ethanol obtained through fermentation of a biomass material such as plants.

Bionaphtha derived from biomass is preferably used as the raw material for the above resin.

The production method of the above bionaphtha derived from biomass is not particularly limited, and bionaphtha can be obtained by any known method. Examples of the production method of above bionaphtha include a method in which ethylene is obtained from ethanol produced through microbial fermentation of a plant material such as sugarcane, or a method in which propane or a naphtha substitute is obtained by recycling tall oil which is a by-product of pulp production or waste edible oil. In this specification, the raw material of bionaphtha is not limited by monomer units, and bionaphtha is used as a collective term.

The above resin is preferably a polymer obtained by polymerizing a monomer containing the above bionaphtha as the main component. The content of bio-derived naphtha in the raw material monomers of the resin may not be 100%. For example, the environmental load can be reduced by using the raw material monomers partially containing bio-derived monomers. In this case, the purity of naphtha may also affect the molecular weight distribution, etc. during polymerization, and the stability may be lowered as compared to resins produced from fossil fuel-derived raw materials due to generation of low molecular weight components and high molecular weight components.

Furthermore, the mass ratio of the biomass-derived bionaphtha with respect to 100% by mass of the polymerization raw materials of the biopolymer is preferably 30% or more, more preferably 50% or more, and even more preferably 70% or more from the viewpoint of further improving the purging performance and reducing the environmental load.

The mass ratio of the above resin with respect to 100% by mass of the purging compound of the present embodiment is 10 to 97% by mass, preferably 20% or more, more preferably 30% or more, and even more preferably 50% or more from the viewpoint of further reducing the environmental load. A ratio of less than 10% by mass is undesirable because the percentage of contribution to the environment in carbon dioxide emissions decreases. More than 97% is undesirable because use of a resin having a bio degree higher than those of resins derived from fossil fuels makes the purging compound more susceptible to influences of impurities and low molecular weight, making it difficult to exhibit the physical properties as a purging compound. If use of a biomass resin causes a decrease in the purging performance, the physical properties can be improved by partially combining a resin derived from fossil fuels. In addition, an inorganic material or a lubricant can also be used as additives.

### Other Components

### Inorganic Compound

Examples of the above inorganic compound include glass filler, calcium carbonate, and talc. In particular, naturally occurring minerals are preferred because of their low environmental load when they are released into the environment.

Each inorganic compound component described above is contained in a mass ratio of preferably 0.1% by mass or more with respect to 100% by mass of the purging compound of the present embodiment. The total mass ratio of the above inorganic compounds is preferably 1% by mass or more and is preferably less than 70% by mass with respect to the 100% mass ratio of the purging compound of the present embodiment from the viewpoint of lowering the residual amount of the purging compound.

### Lubricant

Examples of the lubricant include low molecular weight polyolefin waxes such as paraffin wax, polyethylene wax, and polypropylene wax (preferably, low molecular weight polyolefin waxes derived from petroleum), mineral oils such as mineral-oil, natural waxes such as carnauba wax, and plant-derived waxes such as rice wax, and fluorine-modified resins. The purging compound of the present embodiment preferably contains at least one lubricant selected from the group consisting of low molecular polyolefin waxes, mineral oils, natural waxes, plant-derived waxes, and fluorine modified resins.

Inclusion of the above lubricant in the purging compound increases the miscibility between low molecular weight components of the biopolymer and dirt components and improves the purging performance by increasing the compatibility, suppresses stickiness intrinsic to the biopolymer, and suppresses residual purging compound per se on the metal surface in the machine due to adhesion.

Paraffin waxes and polymer waxes having a molecular weight of 600 to 30,000 are preferred, and those that are solid at room temperature are preferred. It is preferable that the boiling point is 150° C. or higher and the melting point is 40° C. or higher for ease of processing.

Mineral oils are exemplified by liquid paraffin having a molecular weight of 150 to 800, and the boiling point is preferably 150° C. or higher from the viewpoint of the thermal stability.

As fluoropolymers, resins with a molecular weight of 1,000 or more having fluorine groups, such as generally-used polytetrafluoroethylene, are preferred, and a thermal decomposition temperature of 150° C. or higher is more desirable. A fluoropolymer modified with styrene, maleic acid, methacrylic acid, a methacrylic acid ester, or the like may also be used to provide compatibilization.

Natural waxes such as carnauba wax and plant-derived waxes such as rice wax are preferred over generally-used petroleum-derived waxes from the viewpoint of reduction in carbon dioxide emissions.

The mass ratio of the above lubricant with respect to 100% by mass of the purging compound of the present embodiment is preferably 0.1% by mass or more, more preferably 0.5% by mass or more, and even more preferably 1.0% by mass or more. A ratio of more than 20% by mass is undesirable because the lubricant component per se resides, and a ratio of less than 20% by mass is preferred. Furthermore, less than 0.1% by mass is undesirable because the effect of the lubricant becomes insufficient.

Each lubricant component is contained in an amount of 0.01% by mass or more, more preferably 0.1% by mass or more with respect to 100% by mass of the purging compound of the present embodiment, and 30% by mass or more is undesirable because the effect of reducing the environmental load is decreased and thus less than 30% by mass is preferred. For environmental considerations, waxes derived from natural products and plant-derived processed waxes are particularly preferred in view of carbon dioxide emissions.

### Fossil Fuel-Derived Thermoplastic Resin

Examples of the fossil fuel-derived thermoplastic resin include, but are not particularly limited to, polyolefin-based resins, styrene-based resins (such as polystyrene-based resins and acrylonitrile-styrene copolymer resins), and polycarbonate-based resins. Furthermore, the fossil fuel-derived thermoplastic resin may be a virgin thermoplastic resin.

The content of the fossil fuel-derived thermoplastic resin is preferably 1 to 90% by mass, more preferably 3 to 70% by mass, and even more preferably 5 to 50% by mass, when the mass of the purging compound is taken as 100% by mass. As the ratio of fossil fuel-derived thermoplastic resin is increased, control on the viscosity during extrusion and use of a high viscosity resin can be achieved, which can enhance the performance as a purging compound. At the same time, the benefits of reduced environmental load of a resin produced from a biomass material become less likely to be obtained. Therefore, it is desirable to use a combination within the above range. Use of a recycled resin as a raw material has the effect of reducing the environmental load even when a fossil fuel-derived thermoplastic resin is used. Therefore, it is preferable that recycled resin pellets reprocessed from waste materials such as film cut pieces and containers are used.

### Other Additives

The purging compound of the present embodiment may further contain additive used in generally-used purging compounds as other additives. Examples of the above other additives include an antioxidant, a foaming agent, a plasticizer, and a surfactant.

An antioxidant may be added to inhibit thermal degradation and oxidative degradation of the resin. Examples of the antioxidant include generally-used antioxidants such as hindered phenol-based, hydroxylamine-based, and phosphorus-based antioxidants. In order to fully obtain effects of the antioxidant, the antioxidant is added in a content of preferably 0.01% by mass or more, more preferably 0.05% by mass or more, and even more preferably 0.1% by mass or more, when the mass of the purging compound is taken as 100%. The content of the antioxidant is preferably less than 1% by mass, more preferably less than 0.7% by mass, and even more preferably less than 0.5%. A content of less than 0.01% by mass cannot provide sufficient effects, and a content of more than 1% by mass is undesirable because the antioxidant resides inside the a resin processing machine. Inclusion of an optimum amount of an antioxidant can prevent the molecular weight of the resin from lowering and inhibit further degradation of the low molecular weight components in the biomass resin, which prevents reduction in the purging performance.

Examples of the foaming agent include generally-used organic foaming agents and hydrogencarbonates.

Examples of the surfactant include generally-used surfactants, such as alkyl sulfonates which are anionic surfactants; esters of fatty acids, amides, glycerin, polyethylene glycol, etc., which are nonionic surfactants; and alkyl ammonium salts, etc. which are cationic surfactants.

Each component is contained in an amount of preferably 0.01% by mass or more, more preferably 0.1% by mass or more, when the mass of the purging compound is taken as 100% by mass. An amount of 30% by mass or more is undesirable because the effect of reducing the environmental load is lowered, the residual property of the purging compound is reduced, or other reasons.

The mass ratio of the above other components with respect to 100% by mass of the purging compound of the present embodiment is preferably 3 to 97% by mass. The purging compound containing the above resin and the above other components may be used in amounts of the above ranges such that the total mass of these is 100% by mass.

### Production Method of Purging Compound for Resin Processing Machine

A production method of the purging compound for a resin processing machine of the present embodiment is exemplified by a method in which a resin composition containing a biomass resin (e.g., the above resin having a bio degree of 30% or more) is pelletized.

For example, the method of pelletizing a resin composition containing a biomass resin is exemplified by a method in which a resin composition containing a biomass resin is melt-kneaded using a melt kneading machine, such as a kneader, a co-kneader, an extruder, or Banbury mixer, and the resulting melt-kneaded material is extruded into strands, and then formed into pellets using a strand cutter or the like. The melt kneading machine used in this method is preferably an extruder, and more preferably a twin-screw extruder, from the viewpoint that the resin can be sufficiently kneaded. Use of a twin-screw extruder tends to stabilize the extrudability and suppress pulsation, etc. of strands ejected from the extruder. Generally-used apparatuses, such as a preliminarily mixing apparatus, e.g., a tumbler blender, a ribbon blender, and a super mixer, a gravimetric feeder, and the like may be used to mix the components of the purging compound. During the melt kneading, it is desirable to perform open degassing in which degassed substance is removed via a release port (vent) at normal pressure, or to perform reduced-pressure degassing in which degassed substance is removed via a release port (vent) at reduced pressure as necessary.

The temperature of the melt kneading (for example, the temperature of the cylinder when the melt kneading is carried out in an extruder) is preferably set to 330° C. or lower, more preferably 300° C. or lower. The melt kneading temperature is set in view that the residence time of the molten resin in the melt kneading apparatus is desirably as short as possible. The similar function of a purging compound can also be achieved by blending biopolymer pellets with pellets of other active components and additives among the components of the purging compound described above.

The purging compound for a resin processing machine of the present embodiment is produced using the production method of the purging compound for a resin processing machine of the present embodiment described above.

The purging compound for a resin processing machine of the present embodiment has a purging performance superior to those of conventional purging compounds for a resin processing machine because it is produced from a resin composition containing the waste resin described above.

### Purging Method of Resin Molding Processing Machine

A purging method of a resin processing machine of the present embodiment includes using the purging compound for a resin processing machine of the present embodiment described above.

The resin processing machine that can be purged using the purging compound for a resin processing machine of the present embodiment is exemplified by, for example, injection molding machines, extruders, and three-dimensional printers, is are not limited as long as it is a resin processing machine for handling a thermoplastic resin.

### EXAMPLES

Hereinafter, the present disclosure will be described in more detail with reference to Examples and Comparative Examples. The present disclosure is not limited to the following examples unless the gist thereof is exceeded. Components used in Examples and Comparative Examples are as follows.

### Biomass Resin

Biomass resin which were produced by polymerizing bioethanol or bionaphtha as a raw material and had a guaranteed bio degree were prepared and used.
(A-1) Biopolypropylene, bio degree: 90%
   MFR (240° C., 5.0 Kg): 1.5 kg/10 min
   Weight average molecular weight: 250,000
   Mw/Mn: 5.2
(A-2) Biopolypropylene, bio degree: 100%
   MFR (240° C., 5.0 Kg): 0.8 kg/10 min
   Weight average molecular weight: 350,000
   Mw/Mn: 4.9
(A-3) Biopolyethylene, bio degree: 100%
   MFR (240° C., 5.0 Kg): 0.2 kg/10 min
   Weight average molecular weight: 550,000
   Mw/Mn: 6.0
(A-4) Biopolypropylene, bio degree: 90%
   MFR (240° C., 5.0 Kg): 30 kg/10 min
   Weight average molecular weight: 100,000
   Mw/Mn: 10.2
(A-5) Biopolystyrene, bio degree: 100%
   MFR (240° C., 5.0 Kg): 15 kg/10 min
   Weight average molecular weight: 200,000
   Mw/Mn: 3.3

### Lubricant

(B-1) Polyethylene wax, molecular weigh: 1,000
(B-2) Rice wax (powder), bio degree: 50%
(B-3) Carnauba wax (powder), bio degree: 100%

### Inorganic Compound

(C-1) Calcium Carbonate

### Other Components

(D-1) Polypropylene virgin resin, bio degree: 0%
   MFR (240° C., 5.0 Kg) 32 kg/10 min
   Weight average molecular weight: 100,000
   Mw/Mn 8.2
(D-2) Low-density polyethylene (LDPE) virgin resin, bio degree: 0%
   MFR (240° C., 5.0 Kg): 1.5 kg/10 min
   Weight average molecular weight: 250,000
   Mw/Mn: 5.2

### Bio Degree of Purging Compound

Pellets of a purging compound were prepared and the biomass degree was measured by accelerator mass spectrometry (AMS). The measurement was performed in accordance with the latest ASTM D6866 standard.

### Evaluation of Discoloration Due to Thermal Degradation of Purging Compound

A resin composition was preliminarily mixed for 5 minutes using a tumbler blender, and was melt-kneaded as it was using a twin screw extruder (TEM58SS manufactured by Shibaura Machine Co., Ltd.). The extrusion conditions at this step were a cylinder setting temperature of 280° C. and a feed amount of 6 kg/hour. The melt-kneaded product thus obtained was extruded into strands, cooled with water, and then cut by a strand cutter to obtain a purging compound in the form of pellets. The appearance of the pellets was visually observed at this time to observe whether there was any discoloration due to thermal degradation of the pellets. Obvious discoloration is not desirable because it not only causes quality problems, but also leads to reduced physical properties and the like.
⊚ (excellent): White or the color of the raw resin remained almost unchanged
O (good): Discolored into slight yellow
X (poor): Discolored into yellow due to thermal degradation

### Purging Evaluation by Purging Compound

Into an injection molding machine manufactured by Shibaura Machine Co., Ltd. with a mold clamping force of 100 t, 700 g of a black-coloring molding material of polypropylene (hereinafter referred to as “PP”) was fed from the hopper at a cylinder temperature of 240° C., to be used as a previous resin. Screw rotation was continued until purging of the resin was completed. After the rotation was stopped, the residue was allowed to reside at the same temperature for 15 minutes. Thereafter, a purging compound obtained in an example or a comparative example was fed from the hopper to clean the inside. The amount of the purging compound required until the color was changed from black of the PP to the color of the purging compound was determined based on the purged waste discharged from the nozzle, and used as the numerical measure (g) of purgeability.

In addition, a visual observation was made to determine whether or more smoke was emitted from the nozzle and ejected purged waste during the purging evaluation. If a large amount of smoke is emitted, a countermeasure such as local exhaust ventilation is necessary, which is disadvantageous in terms of convenience. It is also undesirable in view of health.

### Evaluation Criteria

### Purgeability:

⊚ (excellent): The amount of purged waste was 300 g or less, and the purgeability was excellent.
O (good): The amount of purging waste is more than 300 g and 600 g or less, and the purgeability was good.
X (poor): The amount of purging waste was more than 700 g, making purging difficult.

### Emission of Smoke:

⊚ (excellent): Almost no smoke was emitted
O (good): Slight smoke was emitted
X (poor): Smoke was emitted

The measurement and evaluation results are summarized in Table 1.

### Examples 1 to 9, Comparative Examples 1 to 2, and Reference Examples 1 to 2

A resin composition containing the respective components at the ratios (% by mass) as listed in Table 1 was preliminarily mixed for 5 minutes using a tumbler blender, and was melt-kneaded as it was using a twin screw extruder (TEM58SS manufactured by Shibaura Machine Co., Ltd.). The extrusion conditions at this step were a cylinder setting temperature of 280° C. and a feed amount of 6 kg/hour. The melt-kneaded product thus obtained was extruded into strands, cooled with water, and then cut by a strand cutter to obtain a purging compound in the form of pellets.

TABLE 1

| | | | | | | | | | | | | | Comparative | | Reference | |
|---|---|---|---|---|---|---|---|---|---|---|---|---|---|---|---|---|
| | | | | Examples | | | | | | | | | Examples | | Examples | |
| | | | | 1 | 2 | 3 | 4 | 5 | 6 | 7 | 8 | 9 | 1 | 2 | 1 | 2 |
| Purging | (A-1) | Biopolypropylene | % by mass | 92 | — | 10 | — | — | 10 | — | — | — | — | — | — | — |
| compound | (A-2) | Biopolypropylene | % by mass | — | 60 | — | 50 | — | — | — | — | 20 | — | — | — | — |
| | (A-3) | Biopolyethylene | % by mass | — | — | 75 | 5 | 90 | 55 | 75 | 4 | — | — | — | — | — |
| | (A-4) | Biopolypropylene | % by mass | — | — | — | — | — | — | — | — | — | 92 | 60 | — | — |
| | (A-5) | Biopolystyrene | % by mass | — | — | — | — | — | — | — | 90 | — | | | | |
| | (B-1) | Polyethylene wax | % by mass | 4 | — | — | 5 | — | — | — | 6 | — | 4 | — | 4 | 5 |
| | (B-2) | Rice wax | % by mass | — | 6 | 3 | — | — | 3 | — | — | — | — | 6 | — | — |
| | (B-3) | Carnauba wax | % by mass | — | — | 2 | — | 5 | 2 | 5 | — | — | — | — | — | — |
| | (C-1) | Calcium carbonate | % by mass | 4 | 34 | 10 | 40 | — | 10 | — | — | 30 | 4 | 34 | 4 | — |
| | (D-1) | Polypropylene | % by mass | — | — | — | — | 5 | — | — | — | 50 | — | — | 92 | — |
| | (D-2) | Low density polyethylene | % by mass | — | — | — | — | — | 20 | 20 | — | — | — | — | — | 95 |
| Evaluation | Bio degree of purging compound | | % | 82 | 63 | 89 | 55 | 95 | 69 | 80 | 94 | 20 | 82 | 58 | 0 | 0 |
| | Discoloration | Evaluation (visual) | — | O | ⊚ | ⊚ | ⊚ | O | ⊚ | ⊚ | O | ⊚ | X | X | ⊚ | ⊚ |
| | after extrusion | | | | | | | | | | | | | | | |
| | Purgeability | Amount of purge waste | G | 440 | 280 | 340 | 270 | 400 | 360 | 420 | 460 | 300 | 750 | 560 | 500 | 480 |
| | | Evaluation | — | O | ⊚ | O | ⊚ | O | O | O | O | ⊚ | X | O | O | O |
| | Smoke | Evaluation (visual) | — | ⊚ | ⊚ | ⊚ | ⊚ | O | ⊚ | ⊚ | O | ⊚ | X | X | ⊚ | ⊚ |

It was found from the evaluation results that the use of biopolymer raw materials with specific physical properties as the resin raw material for the purging compound suppressed emission of smoke and discoloration due to thermal degradation and had higher cleaning properties in Examples as compared to Comparative Examples. Furthermore, in comparison with Reference Examples in which only the virgin resins were used, the purging compounds with no significant difference in physical properties were obtained, making it possible to achieve a product design that contributes to the environment by reducing carbon dioxide emissions.

1. A purging compound for a resin processing machine, the purging compound comprising:
10 to 97% by mass of a resin having a bio degree of 30% or more with respect to 100% by mass of the purging compound,
wherein the resin has a weight average molecular weight of 200,000 or more and 1,500,000 or less, and a ratio of the weight average molecular weight to a number average molecular weight (Mw/Mn) of 8 or less.

2. The purging compound for a resin processing machine according to claim 1, wherein a melt flow rate of the resin at 240° C., 5.0 Kg is 0.1 to 30 g/10 min.

3. The purging compound for a resin processing machine according to claim 1, wherein the resin is a resin obtained by polymerizing at least one selected from the group consisting of bioethanol and bionaphtha as a raw material.

4. The purging compound for a resin processing machine according to claim 1, having a bio degree of 3% to 97%.

5. The purging compound for a resin processing machine according to claim 1, comprising at least one lubricant selected from the group consisting of low molecular polyolefin waxes derived from petroleum, mineral oils, natural waxes, plant-derived waxes, and fluorine modified resins.

6. The purging compound for a resin processing machine according to claim 1, wherein the resin is a polyethylene, polypropylene, or polystyrene-based resin.

7. The purging compound for a resin processing machine according to claim 1, comprising an inorganic compound.

8. A purging method of a resin processing machine, the purging method comprising using the purging compound for a resin processing machine according to claim 1.
